(19) United States
(12) Patent Application Publication
(10) Pub. No.: US 2023/0378802 A1
(43) Pub. Date: Nov. 23, 2023

(54) Multipurpose Battery Pack Component for Electronic Device and Method of Use

(71) Applicant: Dillon Allen, Lawrence, KS (US)

(72) Inventor: Dillon Allen, Lawrence, KS (US)

(21) Appl. No.: 18/168,674

(22) Filed: Feb. 14, 2023

Related U.S. Application Data
(60) Provisional application No. 63/342,684, filed on May 17, 2022.

(51) Int. Cl. H02J 9/06; H02J 7/00

(52) U.S. Cl. CPC H02J 9/06; H02J 7/0063; H02J 7/0068; H02J 7/0048

(57) ABSTRACT

The present invention relates to a novel multipurpose battery pack component designed to secure onto an electronic device for providing electric power for operation of the electronic device. The component electronically couples with the electronic device using an interface and provides electric power stored in the integrated rechargeable battery thereof. The component regulates the power supply based on the power requirements of the electronic device and eliminates the requirement of an electric cord connected to a power outlet for providing power. When the component is not in use for providing electric power, the battery is recharged using an external power cord configured to be connected to an electric power connector. The component is designed to be compatible with different types of household electronic devices including but not limited to a television, a communication device, a computer, and more.

### CROSS-REFERENCE TO RELATED APPLICATION

The present application claims priority to, and the benefit of, U.S. Provisional Application No. 63/342,684, which was filed on May 17, 2022, and is incorporated herein by reference in its entirety.

### FIELD OF THE INVENTION

The present invention relates generally to the field of battery packs for household electronic devices. More specifically, the present invention relates to a novel and multipurpose battery pack component configured to be secured onto an electronic device such as a television, washing machine, mixer, and more. The component is coupled to an internal power circuit of the electronic device and provides electric charge enabling a user to operate the electronic device even during a power outage. The component couples electrically to the electronic device for providing electric power. Accordingly, the present disclosure makes specific reference thereto. Nonetheless, it is to be appreciated that aspects of the present invention are also equally applicable to other like applications, devices, and methods of manufacture.

### BACKGROUND

By way of background, all household electronic devices such as a television, a washing machine, a refrigerator, and more, require electric power for their operation. For providing electric power, commonly, an external power supply such as an alternating current (AC) from a wall-mounted power outlet is used. Many times, the position of the electronic device is such that a power outlet is far from the device and thus, an additional cord is required. In fact, many cords are required for providing electric power in operation of the devices. Managing cords and providing safety to children and pets are common issues faced by individuals. Often, power outlets malfunction, therefore, not enabling individuals to operate the electronic devices. Individuals desire an improved way for providing electric supply to household electronic devices.

Power outages are a common problem faced by individuals around the globe and especially in developing countries, remote areas, and more. Power fluctuation is also a common problem faced by individuals. During a power outage, electronic devices are inoperable due to the need to draw electricity from the outlet. Typical electronic devices cannot be battery powered due to lack of compatibility with standard batteries and battery packs. Further, due to power fluctuations, the electronic devices are at risk of a malfunction and electronic damage. Individuals need an improved method of providing electric power to electronic devices enabling individuals to operate devices safely on demand and/or during a power outage.

Therefore, there exists a long-felt need in the art to deliver power to an electronic device without the need for a power outlet. There is also a long-felt need in the art for a device that enables individuals to operate household electronic devices during a power outage. Additionally, there is a long-felt need in the art for a novel device that eliminates requirements of a dedicated electric cord for providing electric power to an electronic device. Moreover, there is a long-felt need in the art for a device that offers a way to use several different devices when they are typically unusable or inoperable due to a power outage. Further, there is a long-felt need in the art for a device that reduces clutter and tripping hazards due to multiple electric cords. Finally, there is a long-felt need in the art for a battery pack device that maintains use of important electronics such as lights, communication devices, televisions, and refrigerators during a power outage and power fluctuations.

The subject matter disclosed and claimed herein, in one embodiment thereof, comprises a multipurpose battery pack component device designed to secure onto a household electronic device such as a television, a juicer/blender, a washing machine, and more. The battery pack component is electrically coupled to the electronic device using an interface for providing electric power for operation of the electronic device during a power outage. The battery back component includes a rechargeable battery pack for storing electric power and providing the electric power to the electronic device, an electric cord connector for receiving a conventional electric cord for receiving external power supply for recharging the rechargeable battery pack, a power module for regulating power supply to the electronic device, and a sensor for detecting electric power requirements of the electronic device.

In this manner, the battery pack device of the present invention accomplishes all of the forgoing objectives and provides users with a replaceable and rechargeable battery that can deliver power to an electronic device without the need for a power outlet. The component is secured to the electronic device, therefore obviating a requirement of a dedicated power cord, and hence protects against tripping and any other hazards. The component maintains use of important electronics such as lights and televisions during a power outage and/or during power fluctuations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose battery pack component designed to secure onto an electronic device. The battery pack component is electrically coupled to the electronic device for providing electric power for operation of the electronic device. More specifically, the battery back component comprising a rechargeable battery pack for storing electric power and providing the electric power to the electronic device, a LED indicator for indicating remaining power level of the rechargeable battery pack, an electric cord connector for receiving a conventional electric cord for receiving an external power supply for recharging the rechargeable battery pack, a power module for regulating power supply to the electronic device, and a sensor for detecting electric power requirements of the electronic device. The component provides electric power directly to the electronic device and therefore, enabling a user to operate the electronic component in a power outage or without any external power supply.

The subject matter disclosed and claimed herein, in one embodiment thereof, comprises a power source for an electronic device. The power source enables a user to turn on the electronic device without external power supplied by an electric cord to the electronic device. The power source includes a rechargeable battery pack(s) for providing electric power to the electronic device, the power from the battery pack is regulated as per requirements of the electronic device, wherein, the rechargeable battery pack(s) is recharged from an external power supply when not providing power to the electronic device.

In another aspect of the present invention, a method for providing electric power to an electronic device without the need for a power outlet is described. The method includes the steps of providing a multipurpose battery pack component, the component includes a replaceable and rechargeable battery, a LED indicator for indicating remaining power level of the battery, a power sensor for sending electric power requirements of the electronic device; securing the component onto the electronic device such that the component is electronically coupled to the electronic device; turning on the electronic device; providing, by the component, electric power to the power circuit of the electronic device and indicating, by the LED indicator, a remaining power level of the battery pack.

In another aspect of the present invention, a method for operating an electronic device in a power outage is described. The method includes the steps of providing a multipurpose battery pack component, the component includes a replaceable and rechargeable battery, a LED indicator for indicating remaining power level of the battery, a power sensor for sending electric power requirements of the electronic device; securing the component onto the electronic device such that the component is coupled to the electronic device using a wire or a cord; turning on the electronic device; providing, by the component, electric power to the power circuit of the electronic device, thereby enabling the user to operate the electronic device without external power supply.

In yet another embodiment, the multipurpose battery pack component of the present invention is easily and efficiently manufactured, marketed, and available to consumers in a cost-effective manner. Further, the multipurpose battery pack improves the utility and life of the sensitive household electronic devices such as televisions, communication devices, music players, juicers/blenders, washing machines, and more.

In yet another embodiment, an electronic device having an attached replaceable and rechargeable battery component is disclosed. The electronic device is configured to be electronically coupled to the component and further configured to receive electric power from the component without requiring any external power supply.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an electronic device multipurpose battery pack component of the present invention in accordance with the disclosed architecture;

FIG. 2 illustrates a functional block diagram of the electronic device battery pack component of the present invention in accordance with the disclosed architecture;

FIG. 3 illustrates a perspective view showing the battery pack component of the present invention secured onto a television in accordance with the disclosed architecture;

FIG. 4 illustrates a perspective view showing the battery pack component of the present invention secured onto an exemplary electronic device in accordance with the disclosed architecture; and

FIG. 5 illustrates a flow diagram depicting a process of using the electronic device battery component of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art to deliver power to an electronic device without the need for a power outlet. There is also a long-felt need in the art for a device that enables individuals to operate household electronic devices during a power outage. Additionally, there is a long-felt need in the art for a novel device that obviates requirements of a dedicated electric cord for providing electric power to an electronic device. Moreover, there is a long-felt need in the art for a device that offers a way to use several different devices when they are typically unusable/inoperable. Further, there is a long-felt need in the art for a device that reduces clutter and tripping hazards due to multiple electric cords. Finally, there is a long-felt need in the art for a battery pack device that maintains use of important electronics such as lights, televisions, and communication devices during a power outage and power fluctuations.

The present invention, in one exemplary embodiment, is a rechargeable and replaceable power source for an electronic device. The power source enables a user to turn on the electronic device without external power supplied by an electric cord to the electronic device. The power source includes a pack of rechargeable battery(s) for providing electric power to the electronic device, the power from the battery pack is regulated as per requirements of the electronic device, wherein, the rechargeable battery pack is recharged from an external power supply when not providing power to the electronic device.

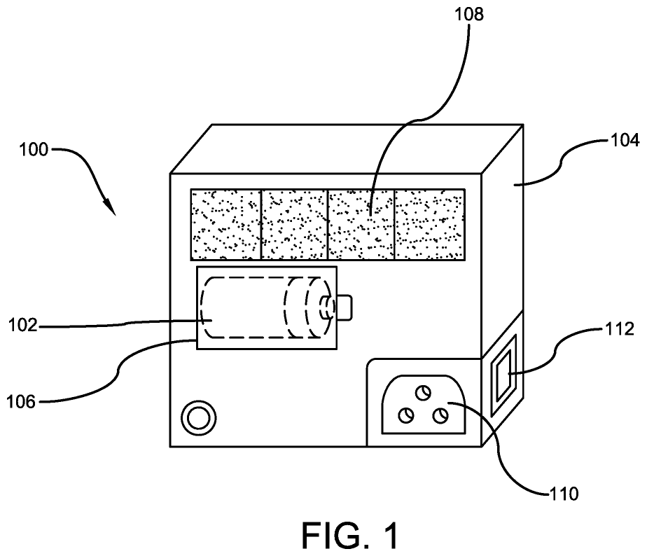

Referring initially to the drawings, FIG. 1 illustrates a perspective view of one potential embodiment of an electronic device multipurpose battery pack component of the present invention in accordance with the disclosed architecture. The multipurpose battery pack component 100 of the present invention is designed as a standalone device to secure onto an electronic device including, but not limited to, a television, a communication device, a computer, a mixer, a washing machine, and more for providing electric power for operation of the electronic device. The electric power provided by the battery pack component 100 can be used for operating the electronic device without need of a conventional power outlet. As a result, the component 100 enables users to activate their electronics during a power outage.

The battery pack component 100 includes an integrated battery 102 disposed in the housing 104 for providing electric power to an electronic device to which the component 100 is secured. The battery 102 is a rechargeable battery and can be designed to have a desired power level to operate the electronic device. The battery 102 can be a Li-ion, Nickel-Cadmium, Nickel-Metal hydride, Lead-acid, and more. The battery 102 is protected by a battery cover 106 that can be removed for accessing the battery 102. An LED indicator 108 is disposed on the housing 104 to indicate the remaining power level of the battery 102 and in one exemplary embodiment, indicates a red color when the remaining power level of the battery 102 is less than a threshold (i.e., 15%) of the total power capacity of the battery 102.

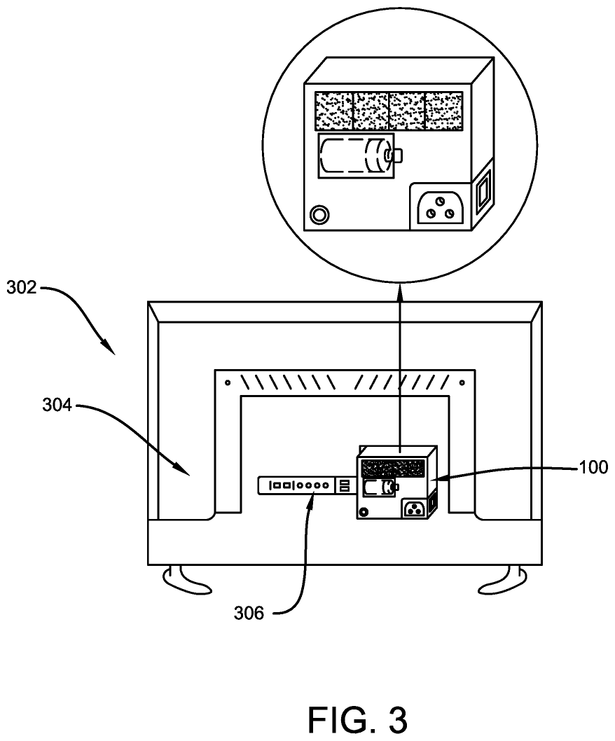

It should be noted that a conventional electric cord can be detachably attached to an electronic cord connector 110. The connector 110 is configured to receive and accommodate a conventional electronic cord port enabling recharging of the battery 102 as illustrated in FIG. 3. An electric charge sensor 112 is disposed in the housing 104 and is used for sensing the electric charge requirements of the electronic device onto which the component 100 is secured such that the desired flow of electric charge is provided to internal circuitry of the electronic device.

The battery pack component 100 can be integrated or retrofitted to an electronic device and is coupled to the internal power circuitry or port of the electronic device. Further, the battery 102 can be removed and replaced with a new rechargeable battery as per preferences of a user or as needed. It should be appreciated that the component 100 maintains use of important electronics such as lights and televisions during a power outage.

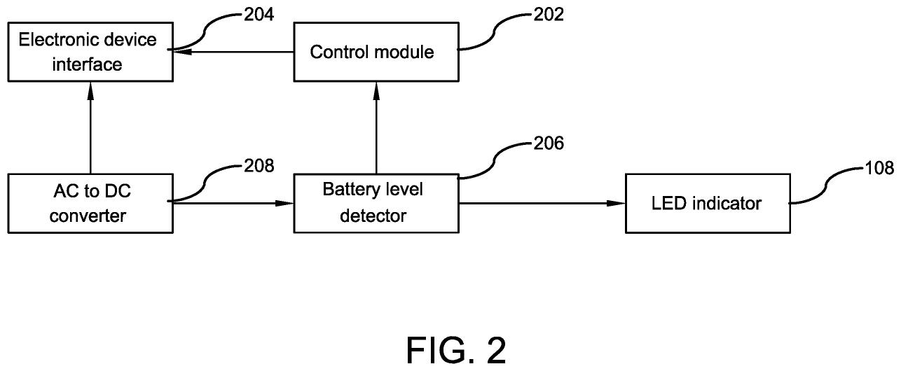

FIG. 2 illustrates a functional block diagram of the electronic device battery pack component 100 of the present invention in accordance with the disclosed architecture. The battery pack component 100 includes a control module 202 preferably in the form of a DC regulator for regulating electric supply supplied to an electronic device. The control module 202 is coupled with the electric charge sensor 112 and regulates the electric charge supply based on the charge requirements detected by the sensor 112.

In one exemplary embodiment, the sensor 112 dynamically detects the electric supply requirement of the electronic device and alternatively, the component 100 can be preconfigured with a specific power supply that is supplied by the control module 202. The control module 202 receives electric charge supply from the battery pack 102 of the component 100 and transfers same to the electronic device. For interfacing with the electronic device, the component 100 has an electronic device interface 204 that electrically couples the component 100 and the electronic device. The electronic device interface 204 can be any wired or wireless interface as known in the state of the art.

A battery level detector 206 of the component 100 is configured to detect the battery power level and provides a signal to the LED indicator 108 for indicating the power level of the battery 102. In one embodiment, the control module 202 is configured to interrupt supply from the battery pack 102 for at least two minutes when the electric cord is not connected to the connector 110 and the battery level is less than a threshold (i.e., 5%) of the total battery power level. Preferably, the electric cord when plugged into connector 110 recharges the battery pack 102 when the battery pack 102 is not supplying electric supply to the electronic device. An AC to DC converter 208 of the component 100 is configured to convert AC supply from a conventional power outlet to DC power such that the converted DC power is easily stored in the battery pack 102 for recharging the battery pack 102.

FIG. 3 illustrates a perspective view showing the battery pack component 100 of the present invention secured onto a television in accordance with the disclosed architecture. As illustrated, the battery pack component 100 is positioned at the rear surface 304 of the television 302 and is coupled to the internal power circuit 306 of the television 302. The component 100 can be integrated to the television 302 or can be retrofitted to the television 302.

In use, when the television 302 starts, electric charge is automatically provided by the battery pack 102 of the component 100. The electric charge sensor 112 detects the active connection of the television 302 and the component 100 and the control module 202 transfers the electric charge to the television 302.

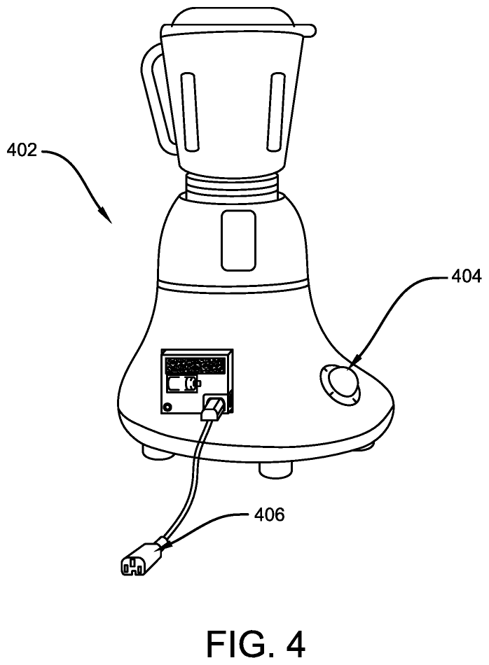

FIG. 4 illustrates a perspective view showing the battery pack component 100 of the present invention secured onto an exemplary electronic device in accordance with the disclosed architecture. In the present embodiment, the battery pack component 100 is coupled to the internal power circuit (not shown) of the mixer device 402. The component 100 is configured to provide the electric power to the mixer 402 and can regulate the power provided to the mixer 402 based on the controlling knob 404 of the mixer 402. The electric cord 406 of the component 100 can be plugged in any conventional power outlet for recharging integrated battery pack 102 of the component 100.

The component 100 of the present invention is designed to adequately provide electric power for at least 3-4 hours to the mixer 402. Further, the component 100 can be integrated or retrofitted to the mixer device 402. The device 100 can be disposed on the body of the electronic device 402 or alternatively can be disposed inside a cavity in the electronic device 402.

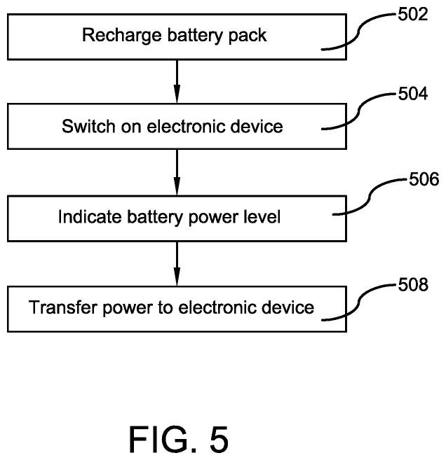

FIG. 5 illustrates a flow diagram depicting a process of using the electronic device battery component of the present invention in accordance with the disclosed architecture. Initially, the battery pack of the component is recharged using conventional electric supply by plugging in electric cord (Step 502). The electric cord can be plugged in any AC or DC power outlet found in homes and businesses. Then, for providing electric supply/charge to an electronic device onto which the component 100 is secured, the electronic device is switched on and the electric power is automatically transferred to the electronic device (Step 504). The battery pack component device 100 indicates visually or alternatively audibly about the power level of the battery pack of the device 100 (Step 506). Finally, transfer of power from the component 100 to the electronic device is stopped when the electronic device is turned off (Step 508).

The electronic device multipurpose battery pack component 100 saves money and conserves electricity at peak hours, as well as brown outs during summer. The electronic device multipurpose battery pack component 100 is also compatible with generators and solar panels, and can function similar to a Bluetooth device.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “electronic device multipurpose battery pack component”, “multipurpose battery pack component”, “component”, “device”, and “electronic device battery pack component” are interchangeable and refer to the electronic device multipurpose battery pack component 100 of the present invention.

Notwithstanding the forgoing, the electronic device multipurpose battery pack component 100 of the present invention can be of any suitable size and configuration as is known in the art without affecting the overall concept of the invention, provided that it accomplishes the above-stated objectives. One of ordinary skill in the art will appreciate that the electronic device multipurpose battery pack component 100 as shown in the FIGS. are for illustrative purposes only, and that many other sizes and shapes of the electronic device multipurpose battery pack component 100 are well within the scope of the present disclosure. Although the dimensions of the electronic device multipurpose battery pack component 100 are important design parameters for user convenience, the electronic device multipurpose battery pack component 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose battery pack connected to an electronic device comprising:
a multipurpose rechargeable battery pack having a housing and a plurality of rechargeable batteries connected to an electronic device for supplying an electric power supply to said electronic device during a power outage;
an electric cord;
an electric cord connector;
an electric cord port;
wherein said electric cord detachably attached to said electric cord connector;
an electric charge sensor disposed in said housing;
wherein said electric cord connector for receiving said electric cord port;
wherein said electric charge sensor for sensing an electric charge requirement of said electronic device and for continuing a flow of said electric power supply to said electronic device; and
further wherein said multipurpose rechargeable battery pack integrated with and coupled to an internal power circuitry of said electronic device.

2. The multipurpose battery pack connected to an electronic device of claim 1, wherein said multipurpose rechargeable battery pack is removable from said housing.

3. The multipurpose battery pack connected to an electronic device of claim 2, wherein said multipurpose rechargeable battery pack is replaceable with another said multipurpose rechargeable battery pack.

4. The multipurpose battery pack connected to an electronic device of claim 3 further comprising a control module having a DC regulator for regulating said electric power supply to said electronic device.

5. The multipurpose battery pack connected to an electronic device of claim 4, wherein said control module coupled with said electric charge sensor to regulate said electric power supply based on the charge requirements detected by said electric charge sensor.

6. The multipurpose battery pack connected to an electronic device of claim 5 further comprising a battery level detector for detecting a power level of said multipurpose rechargeable battery pack.

7. A multipurpose battery pack connected to an electronic device comprising:
a multipurpose rechargeable battery pack having a housing and a plurality of rechargeable batteries connected to an electronic device for supplying an electric power supply to said electronic device during a power outage;
an electric cord;
an electric cord connector;
an electric cord port;
wherein said electric cord detachably attached to said electric cord connector;
an electric charge sensor disposed in said housing;
wherein said electric charge sensor dynamically detects said electric power supply requirement of said electronic device;
a control module for receiving said electric power supply from said multipurpose rechargeable battery pack and transferring said electric power supply to said electronic device;
an electronic device interface electrically coupling said multipurpose rechargeable battery pack to said electronic device;
wherein said electric cord connector for receiving said electric cord port;
wherein said electric charge sensor for sensing an electric charge requirement of said electronic device and for continuing a flow of said electric power supply to said electronic device; and
further wherein said multipurpose rechargeable battery pack integrated with and coupled to an internal power circuitry of said electronic device.

8. The multipurpose battery pack connected to an electronic device of claim 7, wherein said electric power supply is a preconfigured specific said electric power supply.

9. The multipurpose battery pack connected to an electronic device of claim 8, wherein said electronic device interface is wired to said electronic device.

10. The multipurpose battery pack connected to an electronic device of claim 8, wherein said electronic device interface is a wireless interface.

11. The multipurpose battery pack connected to an electronic device of claim 9, wherein said multipurpose rechargeable battery pack is removable from said housing.

12. The multipurpose battery pack connected to an electronic device of claim 11, wherein said multipurpose rechargeable battery pack is replaceable with another said multipurpose rechargeable battery pack.

13. The multipurpose battery pack connected to an electronic device of claim 12, wherein said control module having a DC regulator for regulating said electric power supply to said electronic device.

14. The multipurpose battery pack connected to an electronic device of claim 13, wherein said control module coupled with said electric charge sensor to regulate said electric power supply based on the charge requirements detected by said electric charge sensor.

15. The multipurpose battery pack connected to an electronic device of claim 7 further comprising a battery level detector for detecting a power level of said multipurpose rechargeable battery pack and for providing an LED indicator for indicating said power level of said multipurpose rechargeable battery pack.

16. The multipurpose battery pack connected to an electronic device of claim 15, wherein said control module configured to interrupt said electric power supply from said multipurpose rechargeable battery pack for a period of time when said electric cord is disconnected from said electric cord connector and said power level is below a threshold.

17. A method of using an auxiliary rechargeable battery pack during a power outage, the method comprising the steps of:
connecting an auxiliary rechargeable battery pack to a household electronic device, wherein said auxiliary rechargeable battery pack having an electric power cord;
plugging said electric power cord into an AC power outlet for accessing a conventional power supply;
charging said auxiliary rechargeable battery pack using said conventional electric supply and said electric power cord;
switching ON said auxiliary rechargeable battery pack;
transferring electric power supply from said auxiliary rechargeable battery pack to said household electronic device; and
providing electric power supply to said household electronic device from said auxiliary rechargeable battery pack during the power outage.

18. The method of claim 17 further comprising a step of indicating a power level of said auxiliary rechargeable battery pack.

19. The method of claim 18 further comprising the steps of:
converting said AC power to DC power; and
storing said DC power in said auxiliary rechargeable battery pack for recharging said auxiliary rechargeable battery pack.

20. The method of claim 19, wherein said auxiliary rechargeable battery pack having an electric charge sensor, wherein said electric charge sensor dynamically detects said electric power supply requirement of said household electronic device, and further wherein said electric charge sensor for sensing an electric charge requirement of said household electronic device and for continuing a flow of said electric power supply to said household electronic device.
